(19) United States
(12) Patent Application Publication
(10) Pub. No.: US 2010/0122880 A1
(43) Pub. Date: May 20, 2010

(54) SURFACE CONFIGURATIONS FOR DAMPING INSERTS

(75) Inventors: Michael D. Hanna, West Bloomfield, MI (US); Louis G. Hector, JR., Shelby Township, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/272,164

(22) Filed: Nov. 17, 2008

(51) Int. Cl. B60T 1/06; F16F 7/00; B44C 3/08

(52) U.S. Cl. 188/18 A; 181/207; 156/219

(57) ABSTRACT

One embodiment of a product includes an insert for disposition in or on a component. The insert may have at least one contact surface that can experience relative frictional movement against an adjacent interior surface of the component. The at least one contact surface of the insert may comprise a nominal plane and surface features arranged in a nonstochastic pattern. The insert may also be constructed and arranged for disposition in or on the component to dampen sound when the component is vibrated.

### TECHNICAL FIELD

The technical field of this disclosure relates generally to friction damped devices and to inserts for use in the same.

### BACKGROUND

A number of devices have used friction damping inserts as a mechanism to mitigate unwanted noise outputs. One such example is a brake rotor assembly, which is a common braking device used in motor vehicles. In fact, in today's automobiles, brake rotor assemblies are typically employed at each front wheel, and in many instances at all four wheels, and are even sometimes utilized in conjunction with other braking devices such as drum brake assemblies.

Each brake rotor assembly is generally designed to selectively stop or slow its respective vehicle wheel upon actuation from the vehicle's driver. In most instances this involves forcibly engaging a brake pad or other related braking means against a portion of the brake rotor assembly that co-rotates with the vehicle wheel. And the frictional interaction experienced as a result of this engagement inhibits or halts the continued rotation of the vehicle wheel in accordance with the driver's directive.

But sometimes, during normal and severe braking conditions, a noise phenomena known as brake squeal occurs when parts of a brake rotor assembly vibrate or oscillate at high frequencies. And this can be loud and annoying. As such, a variety of products and methods are being investigated that may help diminish the occurrence, intensity, and longevity of brake squeal emitted from motor vehicle braking systems.

### SUMMARY OF EXEMPLARY EMBODIMENTS

One embodiment of a product includes an insert for disposition in or on a component. The insert may have at least one contact surface that can experience relative frictional movement against an adjacent interior surface of the component. The at least one contact surface of the insert may comprise a nominal plane and surface features arranged in a nonstochastic pattern. The insert may also be constructed and arranged for disposition in or on the component to dampen sound when the component is vibrated.

### BRIEF DESCRIPTION OF THE DRAWINGS

Exemplary embodiments of the invention will become more fully understood from the detailed description and the accompanying drawings, wherein:

FIG. 1 is a side elevational view of a brake rotor assembly according to one embodiment of the invention. The view of brake rotor assembly shown includes a side view of a brake rotor and a cross-sectional view of a brake caliper.

FIG. 2 is a cross-sectional view of a brake rotor according to one embodiment of the invention.

FIG. 3 is a perspective and magnified fragmentary view of an insert that may be disposed in the brake rotor according to one embodiment of the invention.

FIG. 4 is a perspective and magnified fragmentary view of an insert that may be disposed in the brake rotor according to one embodiment of the invention.

FIG. 5 is a perspective and magnified fragmentary view of an insert that may be disposed in the brake rotor according to one embodiment of the invention.

### DETAILED DESCRIPTION OF EXEMPLARY EMBODIMENTS

The following description of the embodiment(s) is merely exemplary in nature and is not intended to limit the scope of the invention, it application, or its uses.

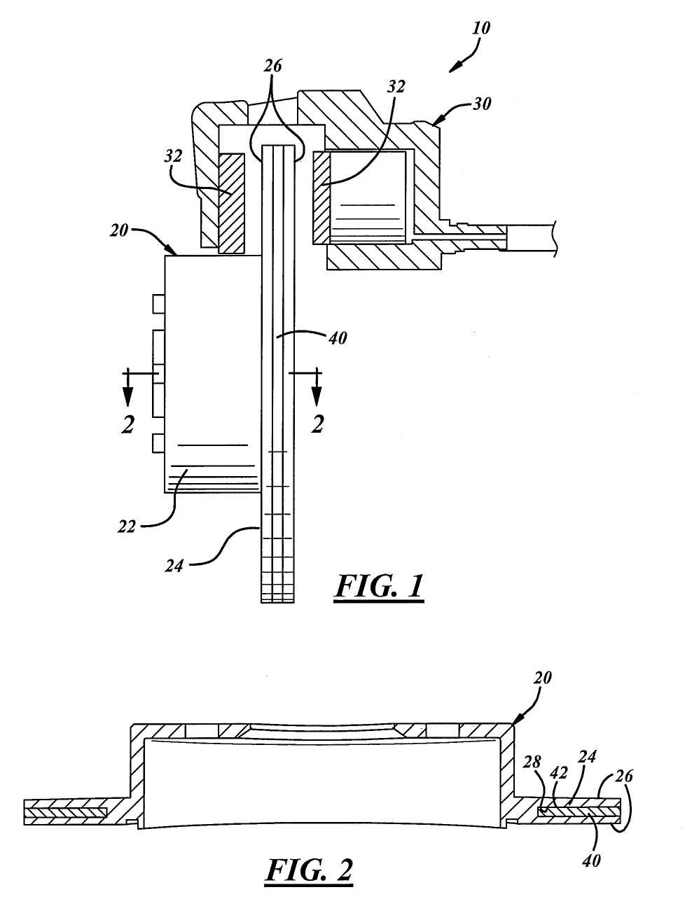

A conventional brake rotor assembly 10, as illustrated in FIG. 1 may include a brake rotor 20 and a brake caliper 30 as its main components. The brake rotor 20 may include a centrally located rotor hat 22 that secures the brake rotor 20 to a vehicle wheel (not shown) so that the two can co-rotate in unison when the vehicle is moving. The brake rotor 20 may also include one or more annular rotor cheeks 24 that extend annularly from the rotor hat 22 and provide the brake rotor 20 with at least one, and usually two, braking surfaces 26 against which brake pads 32 may be selectively engaged when braking is desired. Suitable materials often utilized for forming the brake rotor include ferrous alloys such as iron and non-ferrous metals such as aluminum, titanium and alloys thereof. In some instances, as shown here, the rotor cheek 24 may be of the solid-type and thus provide a braking surface 26 on each of its opposed sides. And in other instances the brake rotor 24 may be of the vented-type; a configuration where a pair of thinner rotor cheeks 24 are separated by a web of ventilation vanes that aid in extracting heat away from the braking surfaces 26. In such a configuration each rotor cheek 24 provides a single opposed braking surface 26 on its outer side so that the two cheeks 24, in combination, provide a pair of opposed braking surfaces 26. Nonetheless, both rotor cheek configurations are well known in the art and, as such, need not be described in further detail here.

The brake caliper 30 may straddle the brake rotor 20 and carry the one or more brake pads 32 in close proximity to the one or more braking surfaces 26 of the brake rotor 24. When desired, the one or more brake pads 32 can be actuated and pressed against the rotor's 20 one or more braking surfaces 26 to generate frictional resistance therebetween. This resistance is what allows the driver to controllably stop or slow the brake rotor 20 and thus the wheel to which it is rigidly secured. In most instances the driver of the vehicle transmits the force needed to actuate the one or more brake pads 32 and achieve the desired braking outcome through a hydraulic, pneumatic, mechanic or electromechanic mechanism, such as, for example, depressing a foot pedal or pulling a hand lever. A wide variety of brake calipers 30 have been developed and thus their exact mechanical design may fluctuate from vehicle to vehicle—most notably from older vehicles to newer ones. In fact, one specific and exemplary type of brake caliper 30 commonly employed in today's automobiles is a single-piston-floating caliper. A notable trait of these types of brake calipers is their ability to self-center and self-adjust upon actuation. Still other types of brake calipers such as duel or four-piston fixed calipers can be found on many automobiles.

When the one or more brake pads 32 engage the one or more braking surfaces 26, however, there is a tendency for the brake rotor 20 to oscillate at frequencies in the range of about 4,000 to about 11,000 Hz. The resulting noise from such an occurrence is oftentimes referred to as “brake squeal.” And it, in addition to being rather annoying, often fosters the perception that the vehicle braking system is damaged or of low quality.

Thus, in one embodiment, as shown best in FIG. 2, at least one insert 40 may be disposed in or on a component of a device such as the rotor cheek 24 or cheeks to friction damp the brake rotor 20 when the one or more brake pads 32 are engaged therewith. The insert 40 may be fabricated from the same or different material from that of the brake rotor 20. For example, the insert 40 may be formed from a metal, a reinforced ceramic, or any other appropriate material. Suitable metals include, but are not limited to, a low-grade steel such as AISI 1010 or 1008, aluminum alloys, titanium alloys, and stainless steel 316. A suitable reinforced ceramic that may be used is a silicon carbide composite. One role of the insert 40 is to convert the mechanical energy contained in the rotor's 20 high frequency oscillations into thermal energy capable of being easily expelled to the surrounding environment. For example, the oscillating brake rotor 20 may cause relative movement to transpire between independent contacting surfaces—such as an exterior contact surface 42 of the insert 40 and an adjacent interior surface 28 of the rotor cheek 24. The frictional interaction between these surfaces 42, 28 can thus absorb and dissipate an appreciable amount of the mechanical energy imparted to the brake rotor 20 such that any surviving oscillations or vibration propagation is diminished.

In one embodiment, the insert 40 may comprise a coating to prevent substantial wetting at the surface interface between the contact surface 42 and the interior surface 28 during brake rotor 20 manufacturing. For instance, such a coating may be useful if the brake rotor 20 is manufactured using a conventional casting procedure. A suitable material that may be used to form the coating may be a refractory-based or graphite-based material. The refractory-based material may include particles of alumina, iron, silica, and/or nickel dispersed in a binder material. The graphite material may be any form of graphite or graphite oxide blends mixed with an organic or inorganic binder, a clay, water, petroleum solvent, or an alcohol. These graphite-based materials may also be treated with a variety of functional groups to enhance the bonding characteristics of the graphite particulate matter. The thickness of the coating may vary considerably depending on the manufacturing process utilized to make the brake rotor 20. For example, when the brake rotor 20 is manufactured by casting, the thickness of the coating may be such that molten metal is prevented from bonding to the contact surface 42 of the insert 40. A typical coating thickness under conventional casting circumstances may range from about 1-650 μm, from about 10-400 μm, from about 30-300 μm, from about 30-40 μm, from about 40-100 μm, from about 100-120 μm, from about 120-200 μm, from about 200-300 μm, from about 300-600 μm, from about 300-550 μm, from about 350-450 μm, or variations of those ranges. The coating may be applied to the contact surface 42 of the insert 40 by any method known to skilled artisans such as baking or physical pressing under a compressive force. An exemplary set of baking conditions that may be appropriate for a graphite-based coating include a baking temperature from about 50° C. to about 500° C. and a baking time from about 5 to about 35 minutes.

The size and shape of the insert 40 may be varied for a multitude of reasons and purposes such as, for example, operational experience or product design requirements. For instance, in one embodiment, the insert 40 may be annularly disposed in the rotor cheek 24 so that immediate friction damping can occur no matter where the one or more brake pads 32 first engage the one or more braking surfaces 26. It may also be substantially coextensive with the rotor cheek 24 in its radial dimension so as to provide an appreciable friction interface between the contact surface 42 of the insert and the interior surface 28. Additional inserts of similar or dissimilar sizes and shapes may also be employed if desired in the rotor cheek.

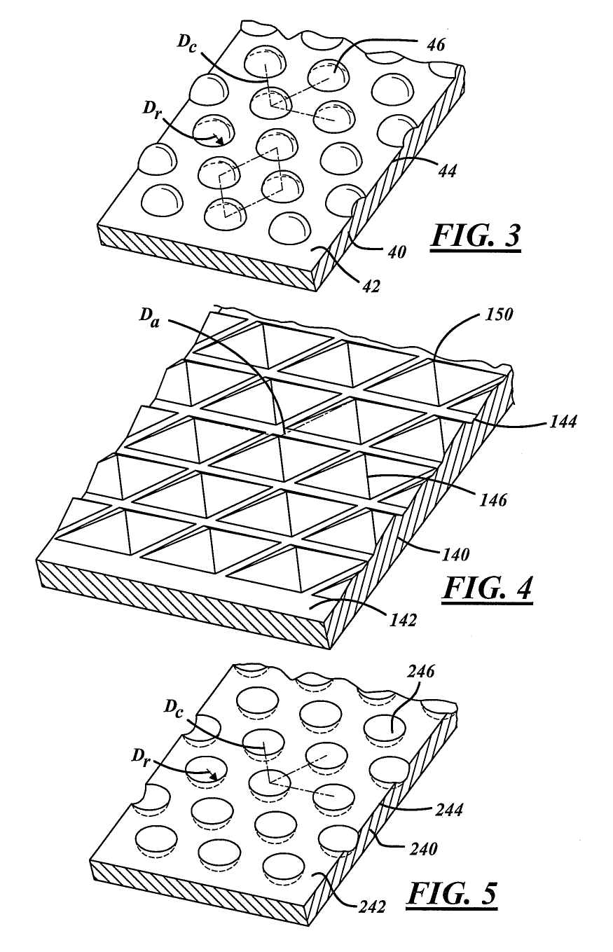

In one exemplary embodiment, as shown in FIG. 3, the contact surface 42 of the insert 40 may be provided with surface features 46 arranged in a nonstochastic pattern so as to further minimize brake squeal by deadening sound transmission to inaudible levels through incoherent sound scattering. The surface features 46 may cover the entire contact surface 42 or they may cover only selective portions thereof. The term “nonstochastic” as utilized here refers to a predetermined pattern where the arrangement of the surface features 46 on the contact surface 42 in relation to one another may be controlled with a relatively high degree of precision. The size of the surface features 46 and the particular nonstochastic pattern employed can also be manipulated so as to deaden sound most effectively at certain target brake rotor 20 oscillation frequencies. Although not explicitly shown in FIG. 3, it should be noted that the opposite side of the insert 40 may, if desired, be similarly configured with the same or a different nonstochastic pattern of surface features. In fact, the insert 40 can be configured such that it comprises spatially correlated surface features on both of its contact surfaces; that is, each surface feature on one contact surface of the insert has a corresponding and axially aligned surface feature on the opposite contact surface. Or, on the other hand, the insert may be configured such the surface features on its contact surfaces are deliberately offset and thus not in axial alignment. As such the discussion of FIG. 3 is meant to apply to both contact surfaces of the insert 40 even though only one surface is described for the sake of simplicity.

In this embodiment at least a portion of the insert 40 may comprise rounded surface features 46 raised above the nominal plane 44—sometimes referred to as the measuring plane—of the contact surface 42. In this configuration the surface features 46 of the contact surface 42 are in periodic contact with the interior surface 28 of the rotor cheek 24 for at least the purpose of experiencing the relative movement required for friction damping. The rounded surface features 46 may, in one embodiment, be hemispherical in shape and be defined by a radius Dᵣ in the range of about 25 μm to about 1500 μm. The features 46 may also be arranged in a diamond pattern (as shown by the dotted diamond shape in FIG. 3) to maintain staggering of the features 46 in both the circumferential and radial directions along the contact surface 42 of the insert 40. This arrangement allows the surface features 46 to be equidistantly spaced apart from their immediately surrounding surface features 46 at center-to-center distances D_{c} that range from about 75 μm to about 4500 μm. The concentration of the equidistantly spaced hemispherical surface features 46 on the contact surface 42 can thus be varied from approximately 5.8×10⁴ surface features/m² to approximately 2.1×10⁸ surface features/m² by modifying the size and space parameters within the ranges just mentioned. And as a general guideline, brake squeal associated sound waves that are emitted from high frequency brake rotor 20 oscillations are dampened more effectively by higher concentrations of surface features 46 than lower concentrations. Similarly, lower concentrations of surface features 46 may be sufficient to effectively deaden brake squeal associated sound waves that are emitted from lower frequency brake rotor 20 oscillations. The particular and often optimized concentration of surface features 46 on the contact surface 42 of the insert 40 can be determined for a number of brake rotor 20 designs and applications through routine experimentation, trial-and-error iterative testing procedures, and/or the experiences of skilled artisans.

It is believed that the nonstochastic pattern of surface features 46 just described deadens sound through at least a couple mechanisms. First, the surface features 46 increase or extend the surface area of the contact surface 42 so that more sound deflection can occur. Moreover, the increased surface area provided by the surface features 42 stiffens the insert 40. This added stiffening can help prevent the insert 40 form warping if it experiences nonhomogeneous thermal expansion during braking. Second, the nonstochastic pattern of the surface features 46 ensures that sound transmission is disrupted to produce randomly scattered sound waves that progressively weaken as they “bounce” between the precisely placed surface features 46 and interfere with one another. And third, the manufacture of the insert 40 and the brake rotor 20 may result in slightly imperfect microengagements between the interior surface 28 of the rotor cheek 24 and the contact surface 42 of the insert that can hamper vibration propagation. For example, if the brake rotor 20 is manufactured by being cast around the insert 40, then it is possible that molten metal material that is to form the rotor cheek may solidify around the surface features 46 of the insert in a manner that results in the formation sporadic micro-air gaps therebetween. Such a phenomenon may be attributed to the surface tension properties of the molten metal and its related tendency to form a molten metal meniscus along the exposed surfaces of the surface features 46. The presence of these micro-air gaps may provide at least two disparate sound transmission mediums—the solid insert material and air—that in combination can help diminish the overall propagation of sound waves through the rotor cheek 24.

The rounded surface features 46 may be formed in a nonstochastic pattern by a variety of precision surface forming techniques. For example, in one embodiment, the surface features 46 may be formed on the contact surface 42 by a chemical etching procedure as known and understood by skilled artisans. Such a procedure generally involves selectively exposing a predetermined portion of a substrate to a chemical reagent capable of controllably dissolving the substrate material. The unexposed or protected portion of the substrate, on the other hand, generally remains unaffected by the chemical reagent. The end result of such a process is that a raised pattern forms in the surface of the substrate.

To form the rounded surface features 46 on the contact surface 42 of the insert 20 so that they that are hemispherically shaped and arranged in a diamond pattern, as described with reference to FIG. 3, an exemplary chemical etching process may first involve providing a substrate blank that may or may not be pre-formed in the shape of the insert 40. The surface of the substrate blank that is to become the contact surface 42 may then be thoroughly cleaned and degreased to help to provide an adherent surface for a later-applied mask and to also ensure that substrate material is uniformly removed during etching. Next, a protective mask that is resistant to the particular chemical reagent that will be used during etching may be applied to the cleaned and degreased surface of the substrate blank. The mask may be designed to cover and protect the localities on the substrate blank that are to become the surface features 46 and to leave exposed those areas in between for removal. Suitable masks may include a variety of elastomers, plastics, or other materials known to skilled artisans that are capable of protecting the substrate blank, and they may be configured as tapes, a curable liquid, or a pre-formed template.

The masked substrate blank may now be exposed to the chemical reagent. At this juncture the chemical reagent attacks the portions of the substrate blank not protected by the mask in a manner that can be controlled by process variables such as, but not limited to, the concentration of the reagent, the exposure time, the temperature of the chemical reagent, and the rate of chemical reagent agitation. Commonly used chemical reagents include hydrochloric and nitric acids (steels), sodium hydroxide (aluminums), ferric chloride (stainless steels), and hydrofluoric acids (titaniums). Nevertheless, these and other chemical reagents and the types of materials they are able to appropriately dissolve during chemical etching are well known to skilled artisans and thus a further discussion of the chemical reagent/substrate material relationship is not necessary here.

The protective mask may be removed after the substrate blank is exposed to the chemical reagent by, for example, scraping, peeling, washing, or some other removal technique. The contact surface 42 with a nonstochastic pattern of surface features 46 is now provided on the substrate blank. This area may now be washed to remove any chemical reagent drag-out to ensure that additional substrate removal does not inadvertently continue. Next, the substrate blank may be formed or machined into the shape of the insert 20, if necessary, and prepared for introduction into the brake rotor 20. Such preparation may include additional machining such as surface polishing, and/or other insert preparation steps such as providing the graphite coating or other appropriate barrier for inhibiting wetting of the contacting surface 42 of the insert 40.

A sand casting procedure may now be employed to form the brake rotor 20 such that the insert 40 is disposed in the rotor cheek 24. At the outset of such a sand casting procedure, the insert 40 may be secured inside a brake-rotor-shaped mold cavity that is formed by a pair of sand die halves. A molten material that is to form the brake rotor 20 may then be introduced into the mold cavity around the insert 40 and allowed to solidify. The sand die halves can then be broken apart in order to remove the brake rotor 20 from the mold cavity. Additional machining or treatments, such as heat treatments, can now be performed on the brake rotor 20 to further advance it towards becoming operational in a motor vehicle.

While the rounded surface features 46 raised above the nominal plane 44 of this embodiment have been described as hemispherical in shape and arranged in a diamond pattern, it should be understood that other alternative designs are possible. For example, the rounded surface features 46 may be defined by a variety of cross-sections such as paraboloidal or elliptical. Also, the rounded surface features 46 may be arranged in other nonstochastic patterns such as a hexagonal pattern or one in which the surface features 46 are arranged in a plurality of concentric circles that are aligned in relation to one another in both the circumferential and radial directions along the contacting surface 42 of the insert 40. Moreover, other precision surface forming techniques can be utilized to form the nonstochastic pattern of rounded surface features 46. These techniques include forging, hot rolling, and knurling.

FIG. 4 shows an alternative exemplary embodiment that is similar in many respects to the embodiment of FIG. 3 such that those similarities need not be repeated here. At least one difference in this embodiment is that at least a portion of the insert 140 may comprise a nonstochastic pattern of sharp-edged surface features 146 raised above the nominal plane 144 of the contact surface 142. The sharp-edged surface features 146 may include four triangular sides that meet in an apex 150 which can assume a height of about 25 μm to about 1500 μm above the nominal plane 144. The surface features 146 may also be arranged so that their apexes 150 define a diamond pattern similar to that of the previous embodiment; that is, the apexes 150 of the surface features 146 may be staggered in the radial and circumferential directions along the contact surface 142 and also be equidistantly spaced apart from one another at apex-to-apex distances Dₐ that range from about 75 μm to about 4500 μm. Possible methods for forming a nonstochastic pattern of the four-sided sharp-edged surface features 146 just described include knurling and photoetching.

While the sharp-edged surface features 146 raised above the nominal plane 144 of this embodiment have been described as including four sides, meeting in an apex 150, and being arranged in a diamond pattern, it should be understood that other alternative designs are possible. For example, the sharp-edged surface features 46 may include three sides, or be truncated so that the top of the surface features 146 are flat instead of pointed. The sharp-edged surface features 146 may also be arranged in other known nonstochastic patterns including those mentioned in the previous embodiment. Other precision surface forming techniques that can be utilized to form the nonstochastic pattern of sharp-edged surface features 146 include precision laser and electron beam machining as disclosed in U.S. Pat. No. 5,789,066 to DeMare et al.

FIG. 5 shows an alternative exemplary embodiment that is similar in many respects to the embodiment of FIG. 3 such that those similarities need not be repeated here. At least one difference in this embodiment is that at least a portion of the insert 240 may comprise a nonstochastic pattern of surface features 246 depressed below the nominal surface 244 of the insert 240. The surface features 246 may be hemispherical in cross-section and defined by the same radius, spacing, concentration, and nonstochastic pattern arrangement parameters described with respect to the rounded surface features 46 of FIG. 3. Here, however, the depressed nature of the surface features 246 places the nominal plane 244 of the contact surface 242—as opposed to the surface features in FIG. 3—into contact with the interior surface 28 of the rotor cheek 24 for the purpose of experiencing the relative movement required for friction damping.

The surface features 246 of this embodiment may be formed in a nonstochastic pattern by a variety of precision surface forming techniques. For example, to form surface features 246 depressed below the nominal plate 244 that are hemispherical in cross-section and arranged in a diamond pattern on the contact surface 242, a focused energy electron beam laser device may be utilized. A devise of this kind can generally emit electron beam pulses of very high energy at a substrate surface that is to become the contacting surface 242 of the insert 240. The electron beam pulse quickly liquefies and then vaporizes the substrate at predetermined localities along the contacting surface 242; the result being hemispherical surface features 246 depressed into the contact surface 242 at those localities. To help arrange the surface features 246 in a nonstochastic diamond pattern, a suitable number of algorithms may be utilized to control the timing and placement of the electron beam pulses. An example of such an algorithm can be found in “Focused Energy Beam Work Roll Surface Texturing Science and Technology,” Journal of Materials Processing and Manufacturing Science, Volume 2, Number 1, July 1993, pp. 102-104, which relates to electron beam texturing of cylindrical tool steel surfaces that rotate beneath a pulsed electron beam.

While the surface features 246 depressed below the nominal plane 44 of this embodiment have been described as hemispherical in cross-section and arranged in a diamond pattern, it should be understood that other alternative designs are possible. For example, the surface features 246 may exhibit other cross-sections and be arranged in other nonstochastic patterns such as those mentioned in the embodiment of FIG. 3. Moreover, other precision surface forming techniques can be utilized to form the nonstochastic pattern of surface features 246 depressed below the nominal plane 244. These techniques include an electric discharge device, a CO₂ laser, a Nd:YAG solid state laser, or mechanical techniques such as embossing.

The above description of embodiments of the invention is merely exemplary in nature and, thus, variations thereof are not to be regarded as a departure from the spirit and scope of the invention. Skilled artisans will understand that the subject matter of this disclosure can be used in a wide variety of devices. Such other devices include magnesium sub-systems in automobiles in which foam structures that contain plastic inserts having the nonstochastic patterned topographies described above could be used to deaden sound transmission through components formed of lightweight magnesium alloys.

What is claimed is:

1. A product comprising:
an insert for disposition in or on a component, the insert having at least one contact surface that can experience relative frictional movement against an adjacent interior surface of the component, the at least one contact surface of the insert comprising a nominal plane and surface features arranged in a nonstochastic pattern, the insert being constructed and arranged in or on the component to dampen sound when the component is vibrated.

2. The product of claim 1, wherein the nonstochastic pattern comprises a diamond pattern in which the surface features are equidistantly spaced apart from their immediately surrounding surface features at center-to-center distances that range from about 75 μm to about 4500 μm.

3. The product of claim 1, wherein the contacting surface of the insert has a concentration of surface features that ranges from about 5.8×10⁴ surface features/m² to about 2.1×10⁸ surface features/m².

4. The product of claim 1, wherein the surface features are rounded.

5. The product of claim 4, wherein the surface features are hemispherical in shape and raised above nominal plane for contact with the adjacent interior surface of the component.

6. The product of claim 5, wherein the surface features comprise a radius of about 25 μm to about 1500 μm.

7. The product of claim 4, wherein the surface features are hemispherical in shape and depressed below the nominal plane so that the nominal plane contacts the adjacent interior surface of the component.

8. The product of claim 7, wherein the surface features comprise a radius of about 25 μm to about 1500 μm.

9. The product of claim 1, wherein the surface features are sharp-edged.

10. The product of claim 9, wherein the surface features are four-sided pyramids with the sides meeting at an apex.

11. The product of claim 1, wherein the component comprises a brake rotor and the insert is shaped for circumferential disposition in the rotor cheek so that the entire contacting surface of the insert comprises the nonstochastic pattern of surface features.

12. A brake rotor assembly comprising:
a brake caliper that carries one or more brake pads;
a brake rotor that includes a rotor hat secured to a vehicle wheel and a rotor cheek positioned annularly around the rotor hat, the rotor cheek having an interior surface and an exterior braking surface near the one or more brake pads such that the brake pads can be selectively engaged against the exterior braking surface; and
an insert disposed in or on the rotor cheek and comprising at least one contact surface that experiences relative frictional movement with the interior surface of the rotor cheek, the at least one contact surface comprising a nominal plane and surface features arranged in a nonstochastic pattern such that the surface features are spaced apart at center-to-center distances that range from about 75 μm to about 4500 μm.

13. The product of claim 12, wherein the nonstochastic pattern comprises a diamond pattern in which the surface features are equidistantly spaced apart from their immediately surrounding surface features.

14. The product of claim 13, wherein the surface features are hemispherical in shape and raised above the nominal plane of the contacting surface, the surface features having a radius about 25 μm to about 1500 μm.

15. The product of claim 13, wherein the surface features are hemispherical in shape and depressed below the nominal plane of the contacting surface, the surface features having a radius of about 25 μm to about 1500 μm.

16. The product of claim 13, wherein the surface features are shaped as four-sided pyramids in which the sides meet at an apex.

17. The product of claim 13, wherein the insert is annularly shaped so that the contact surface is in continuous contact with the interior surface of the rotor cheek along the entire circumference of the rotor cheek.

18. The product of claim 13, wherein the contacting surface of the insert has a concentration of surface features that ranges from about 5.8×10⁴ surface features/m² to about 2.1×10⁸ surface features/m².

19. A method comprising:
providing a substrate blank;
forming surface features arranged in a nonstochastic pattern on at least one surface of the substrate blank using a precision surface forming technique capable of forming the surface features so that the features meet predetermined shape and spacing parameters;
incorporating the substrate blank into a component such that the at least one surface of the substrate blank with the nonstochastic pattern of surface features formed thereon can experience relative frictional movement with a surface of the component to dampen the component.

20. A method as set forth in claim 19, wherein forming the surface features comprises forming, on the at least one contacting surface, a nonstochastic pattern that comprises a diamond pattern in which the surface features are equidistantly spaced apart from their surrounding surface features at center-to-center distances that range from about 75 μm to about 4500 μm.

21. A method as set forth in claim 19, wherein forming the surface features comprises forming surface features that are hemispherical in shape and raised above a nominal plane of the at least one contacting surface of the substrate blank.

22. A method as set forth in claim 19, wherein forming the surface features comprises forming surface features that are hemispherical in shape and depressed below a nominal plane of the at least one contacting surface of the substrate blank.

23. A method as set forth in claim 19, wherein forming the surface features comprises forming surface features that are four-sided and pyramidal in shape and raised above a nominal plane of the at least one contacting surface of the substrate blank.
